(19) United States
(12) Patent Application Publication
(10) Pub. No.: US 2015/0058128 A1
(43) Pub. Date: Feb. 26, 2015

(54) METHOD AND APPARATUS FOR PROVIDING NEIGHBORHOOD-BASED RINGTONE ADVERTISEMENTS

(71) Applicants: Lik Hang Chow, Beijing (CN); Wenwei Xue, Beijing (CN)

(72) Inventors: Lik Hang Chow, Beijing (CN); Wenwei Xue, Beijing (CN)

(21) Appl. No.: 14/375,934

(22) PCT Filed: Apr. 28, 2012
(86) PCT No.: PCT/CN2012/074899

§ 371 Date: Jul. 31, 2014

(51) Int. Cl. G06Q 30/02; H04W 4/02; H04M 19/04; H04W 4/20

(52) U.S. Cl. CPC G06Q 30/0267; H04W 4/206; H04W 4/021; H04M 19/04
USPC 705/14.64; 455/414.2

(57) ABSTRACT

An approach is provided for sending a neighborhood-based ringtone advertisement. The approach involves receiving a ringtone request from a mobile communication device, wherein contextual information of the mobile communication device is determined and processed. The approach also involves determining the neighboring mobile communication devices, and then determining and processing the contextual information associated with the neighboring mobile communication devices. The approach further involves determining a ringtone that has the best influence on the users of the request sending mobile communication device, and the users of the neighboring mobile communication devices. Then, a neighborhood-based ringtone advertisement is selected.

### BACKGROUND

Service providers and device manufacturers (e.g., wireless, cellular, etc.) are continually challenged to deliver value and convenience to consumers by, for example, providing compelling network services. One such service is the provisioning of ringtone advertisements. Existing context-based ringtone advertisement services on mobile communication devices do not utilize the ringtone channel properly, the advertisement content is mainly picked based on the context of a single user, which is usually the mobile device owner, and sometimes based on the caller of an incoming call. During the dynamic ringtone selection, the contexts of other users nearby (e.g., within a neighborhood, or neighbors) are never considered. Hence, when a ringtone is played as an audio broadcast in the neighborhood and is heard not only by the mobile device owner, but also by people within a certain range (e.g., the neighbors), the ringtone is less effective because the ringtone may not be of interest to the neighbors. Therefore, service providers and device manufacturers face significant challenges in providing ringtone advertisements that consider the contexts of neighboring users.

### SOME EXAMPLE EMBODIMENTS

Therefore, there is a need for an approach for providing a neighborhood-based ringtone advertisement that better utilizes audible ringtones on mobile devices as advertising channels. This broadcast nature of selecting and playing a ringtone on a device based on real-time multi-user contexts provides a stronger advertising effect.

According to one embodiment, a method comprises determining contextual information associated with at least one device and one or more neighboring devices. The method also comprises processing and/or facilitating a processing of the contextual information to determine at least one ringtone for the at least one device.

According to another embodiment, an apparatus comprises at least one processor, and at least one memory including computer program code for one or more computer programs, the at least one memory and the computer program code configured to, with the at least one processor, cause, at least in part, the apparatus to determine contextual information associated with at least one device and one or more neighboring devices. The apparatus is also caused to process the contextual information to determine at least one ringtone for the at least one device.

According to another embodiment, a computer-readable storage medium carries one or more sequences of one or more instructions which, when executed by one or more processors, cause, at least in part, an apparatus to determine contextual information associated with at least one device and one or more neighboring devices. The apparatus is also caused to process the contextual information to determine at least one ringtone for the at least one device.

According to another embodiment, an apparatus comprises means for determining contextual information associated with at least one device and one or more neighboring devices. The apparatus also comprises means for processing and/or facilitating a processing of the contextual information to determine at least one ringtone for the at least one device.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: an apparatus comprising means for performing the method of any of originally filed claims 1-20 and 36-38.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing neighborhood-based ringtone advertisements, according to one embodiment;

FIG. 2 is a diagram of the components of an advertisement platform, according to one embodiment;

FIG. 3 is a flowchart of a process for determining a ringtone for a device, according to one embodiment;

FIG. 4 is a flowchart of a process for determining a ringtone playback range, according to one embodiment;

FIG. 5 is a flowchart of a process for determining a provided ringtone, according to one embodiment;

FIG. 6 is a flowchart of a process for determining updates in context information, according to one embodiment;

FIG. 7 is a ladder diagram that illustrates a sequence of processes used in a neighborhood based ringtone advertisement, according to one embodiment;

FIG. 8 is a diagram of one or more user interfaces utilized in the process of FIGS. 4-6, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for providing neighborhood-based ringtone advertisements are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

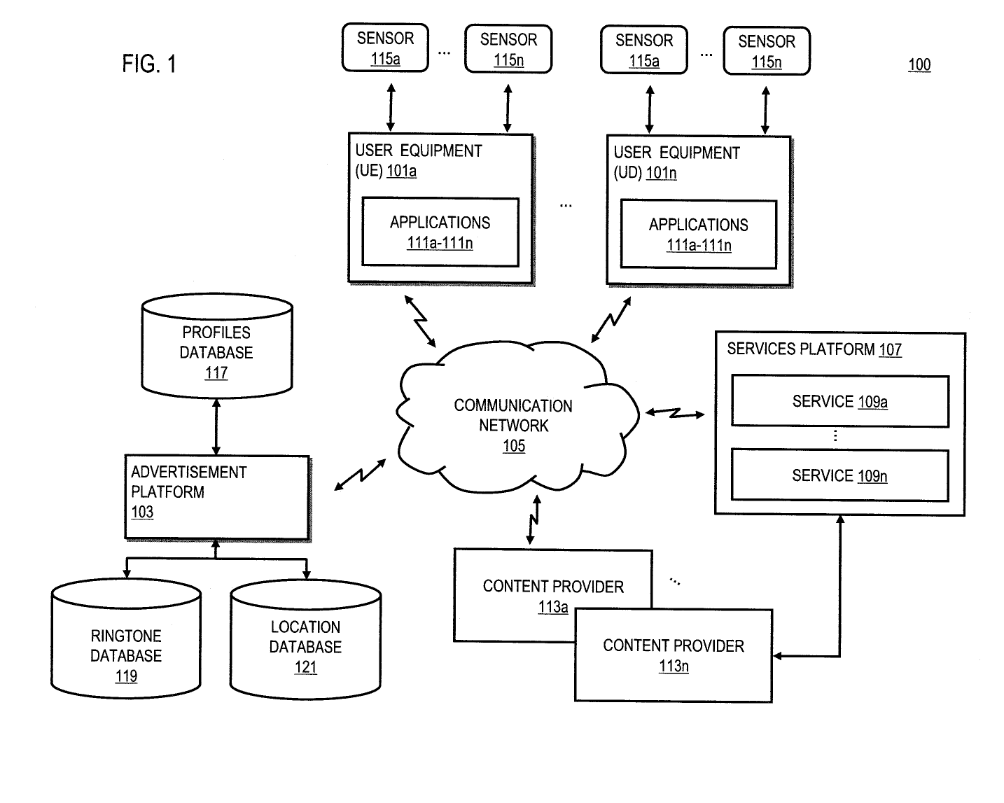

FIG. 1 is a diagram of a system capable of providing neighborhood-based ringtone advertisements, according to one embodiment. The existing context-based ringtone advertisement services on mobile communication devices do not utilize the ringtone channel properly. Specifically, existing context-based ringtone advertisement services mainly determine ringtones based on the context of a single user. Primarily, the single user is the user of the mobile device at which a call is received. Thus, during the dynamic ringtone selection, the contexts of other users nearby (e.g., neighbors) are not considered. Hence, when a ringtone is played as an audio broadcast in the neighborhood and is heard not only by the mobile device owner but also by people within a certain range of the mobile device owner, the ringtone is less effective because the ringtone may not be of interest to nearby people. Rather, the ringtone may be of interest to only the owner of the mobile device. Further, in some instances, the effect is even worse when the ringtone may be based on the caller, and thus the ringtone is not even based on the context of the owner of the mobile phone. Such ringtones have weak advertisement effects and may be a nuisance for the neighborhood.

To address this problem, a system 100 of FIG. 1 introduces the capability of providing neighborhood-based ringtone advertisements. The system 100 provides the ability to attract the attention of nearby users by giving priority to their preferences when sending a ringtone to a user of a mobile device and provides for a better utilization of an audible ringtone on a mobile device as an advertising channel The broadcast nature of selecting and playing a ringtone on a device based on real-time multi-user contexts provides for a stronger advertising effect. Whenever a ringtone is played on a user's mobile device, the system 100 may dynamically select an audible advertisement as the ringtone based on the contexts of the device owner as well as other people who are currently nearby and will likely hear the ringtone. For example, in one embodiment, the content may be audio content (or video content with sound) that can be processed into segments that are usable as ringtones.

The ringtones may be first created by extracting segments from source audio or video files. In the present embodiment, these audio or video ringtone files are provided by a third party, e.g., from an advertising agency representing various clients, and such files are supplied over a network. By way of example, ringtones may be deployed to mobile phones using a combination of mobile messaging, such as SMS and MMS, and internet technologies such as WAP.

FIG. 1 is a diagram of a system capable of providing neighborhood based ringtone advertisements, according to one embodiment. As shown in FIG. 1, the system 100 comprises user equipment (UE) 101a-101n (collectively referred to as UE 101) that may include or be associated with applications 111a-111n (collectively referred to as applications 111) and sensors 115a-115n (collectively referred to as sensors 115).

The applications 111 may be any type of application that is executable at the UE 101. By way of example, the applications 111 may be media (e.g., audio, video, images, etc.) player applications, social networking applications, navigational applications, calendar applications, content (e.g., audio, video, images, etc.) provisioning services, etc. In one embodiment, the applications 111 may generate contextual information regarding the UE 101, or information that may be processed to determine contextual information associated with the UE 101. By way of example, an application may determine location information associated with the UE 101 that may be processed as contextual information. In one embodiment, one of the applications 111a at the UE 101 may act as a client for the advertisement platform 103 and perform one or more functions associated with the functions of the advertisement platform 103. By way of example, the client application 111a may update the location of the UE 101 at the advertisement platform 103, may request one or more ringtones before a ringtone is played at the UE 101, or a combination thereof.

The sensors 115 may be any type of sensor. In one embodiment, the sensors 115 may include one or more sensors that are able to determine contextual information associated with the UE 101, the users of the UE 101, or a combination thereof. By way of example, the sensors 115 may include location sensors (e.g., GPS), light sensors, moisture sensors, pressure sensors, audio sensors (e.g., microphone), etc. In one embodiment, one or more receivers for different short-range communications, such as Bluetooth, WiFi, etc., may be considered sensors that can determine the number and type of neighboring devices within the vicinity of a UE 101.

The UE 101 have connectivity to an advertisement platform 103, a services platform 107 including services 109a-109n (collectively referred to as services 109) and content providers 113a-113n (collectively referred as content providers 113) via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

The services platform 107 including the services 109 may include any type of service. By way of example, the services 109 may include social networking services, content (e.g., audio, video, images, etc.) provisioning services, navigational services, application services, storage services, contextual information determination services, location based services, information (e.g., weather, news, etc.) based services, etc. The contextual information determination services may determine contextual information associated with the UE 101 to supplement or aid in the contextual information acquired by the applications 111 and/or the sensors 115. The services 109 may interact with the UE 101, the advertisement platform 103, and the content providers 113.

By way of example, a social networking service 109a is an online service that reflects social networks or social relations among people that may, for example, share relationships, interests and/or activities. A social networking service 109a essentially consists of a representation of each user (often a profile), his/her social links, and a variety of additional information. The social networking service 109a allows users to share ideas, activities, events and interests within their individual networks, and provides for data portability. The social networking service 109a may assist in providing the advertisement platform 103 with contextual information associated with user profile information, user preference information, location information, temporal information, activity information or a combination.

The content providers 113 may provide content to the UE 101, the advertisement platform 103 and the services 109 of the services platform 107. The content provided may be any type of content, such as audio content (e.g., ringtones), video content, image content, etc. In one embodiment, the content providers 113 may provide content information that may supplement content information determined by one or more of the applications 111, the sensors 115, or a combination thereof. By way of example, the content providers 113 may provide information content that may include contextual information (e.g., weather information, news information, etc.) that may be processed or aid in the processing of contextual information associated with one or more of the UE 101. In one embodiment, the content providers 113 may also store content associated with the UE 101, the advertisement platform 103 and/or the services 109. In one embodiment, the content providers 113 may manage access to a central repository of data, and offer a consistent, standard interface to data, such as a repository of ringtones and/or audio advertisements.

The advertisement platform 103 performs the functions of providing neighborhood-based ringtone advertisements. Although illustrated as a separate element of the system 100 in FIG. 1, the advertisement platform 103, or one or more functions performed by the advertisement platform 103, may be embodied in one or more other elements of the system 100, such as in one or more applications 111 on the UE 101 or one or more services 109. Associated with the advertisement platform 103 are a profiles database 117, a ringtone database 119, and a location database 121. The profiles database 117 may includes profile information associated with the client devices (e.g., UE 101) of the advertisement platform 103. The ringtone database 119 may include the ringtones that are selected by the advertisement platform 103 and transmitted to the client devices. The location database 121 may include information pertaining to the locations of the client devices and information regarding neighborhoods based on groups of client devices and their corresponding locations. In one embodiment, the location information of the client devices may be included within the profiles database 117 rather than in a separate database.

The advertisement platform 103 may determine a sound (e.g., a ringtone, an alarm, a notification, etc.) that is played by a mobile device upon the occurrence of an event at the mobile device. The event may include, for example, the device receiving an incoming communication (e.g., call, SMS message, MMS message, email, etc.), upon an alarm activating, upon a reminder occurring (e.g., an appointment, a calendar event, etc.), or the like. Upon the occurrence of the event, the advertisement platform 103 may dynamically select a ringtone and/or audible advertisement (sound) based on the contextual information associated with the device at which the event occurred and/or the owner of the device, in addition to other devices and/or other owners of the other devices that are in the vicinity of the device and who are likely to hear the ringtone.

The advertisement platform 103 may compute a set of preferred ringtone advertisements for users associated with the advertisement platform 103. The preferred ringtone advertisements may be based on user profiles, such as interests, shopping history, home/office locations, etc. The preferred ringtones may be dynamically updated as the advertisement platform 103 receives updates to the user profiles. This information may be stored for each user within the profiles database 117 associated with the advertisement platform 103, as illustrated in FIG. 1. In one embodiment, the preferred ringtone advertisements may be ordered according to the users' preferences.

Additionally, users associated with the advertisement platform 103 may periodically update their locations with the advertisement platform 103 such that the advertisement platform 103 is aware of the positions of the users. The positions of the users may be determined and updated based on the location of the users' associated devices and based on, for example, one or more applications 111 updating the location information at the advertisement platform 103. In one embodiment, a service 109 may alternatively update the locations of the users at the advertisement platform 103. This information may be stored in the location database 121 associated with the advertisement platform 103, as illustrated in FIG. 1. Based on the location information, the advertisement platform 103 can determine neighborhood information, or groups of users that are within a certain vicinity of another user and/or device that are associated with the advertisement platform 103. The locations of the devices may be dynamic, such that the neighborhoods are also dynamic The advertisement platform 103 includes the ability to determine neighborhoods and the associated users continuously and in real time based on the location information received from the UE 101 according to certain update intervals. In one embodiment, the advertisement platform 103 may control the update intervals.

The advertisement platform 103 determines the neighborhoods based on the location information associated with the devices. In one embodiment, the devices may determine the location information according to, for example, GPS, cell ID, WiFi, Bluetooth, etc. based on being in short-range communication with other devices and send this information to the advertisement platform 103. Under this approach, a peer-to-peer method may be employed to determine the neighborhoods. Further, service users that are near to each other may collaboratively pick the ringtone advertisement. In such an embodiment, the devices may store information regarding the preferred ringtones. Prior to playing a ringtone, a device may then broadcast a ringtone request to all nearby devices using, for example, short-range data communication or an audio-based broadcasting. The audio-based broadcasting may be associated with an inaudible probing audio wave that is broadcasted and detected by nearby devices (e.g., using the microphones). According to this approach, this ability of the other devices to detect the inaudible probing audio wave concurrently determines a subsequent ringtone coverage area. Once neighboring devices receive the broadcast ringtone request, the neighboring devices may respond. The response may include preferred ringtone identifiers for all of the responding devices. A client application 111a at the UE 101 may process the ringtone identifiers to select a ringtone for the neighborhood or could transmit the ringtone identifiers to the advertisement platform 103 for the advertisement platform 103 to determine and select a ringtone. Once the ringtone is determined (and/or requested), the advertisement platform 103 may transmit the ringtone to the requesting device.

Upon receiving a request for a ringtone from a device, the advertisement platform 103 may dynamically determine the neighborhood associated with the device. A device may include the current microphone volume level in the ringtone request. However, in one embodiment, the device may send the current microphone volume level only if there is a threshold change since the previous microphone volume level for the previous request. Based on the microphone level in the request, the advertisement platform 103 may determine the effective spatial coverage of the ringtone playing at the specific time based on, for example, the damping of sound levels with distance. The advertisement platform 103 may then determine the current devices or users within the vicinity of the requesting device based on the information stored in the location database 121. Upon determining the nearby users, the advertisement platform 103 may determine a ringtone advertisement that has an overall best influence on the group of users. By way of example, the advertisement platform 103 may pick the ringtone that appears in the preferred sets of most of the users. By way of another example, the advertisement platform 103 may aggregate the weights of each ringtone appearing in the preferred sets of a few users and pick the ringtone with the largest weight. After picking the ringtone, the advertisement platform 103 sends the ringtone to the requesting device.

The advertisement platform 103 may determine contextual information associated with a device and at least one neighboring device. The contextual information may include, for example, the location of the device and the at least one neighboring device. The contextual information may also include, for example, the current background noise or environmental noise within the vicinity of the device and the at least one neighboring device. The advertisement platform 103 further processes the contextual information to determine at least one ringtone for the device. Because the advertisement platform 103 takes into account the device and the at least one neighboring device when determining the ringtone, the ringtone may be an effective advertisement that the users of the device and the at least one other device may better appreciate and act on in the event that the ringtone is, for example, an advertisement.

In order to provide neighborhood-based ringtone advertisements, the advertisement platform 103 determines the ringtone playback capability information associated with the device and processes the ringtone playback capability information to determine the ringtone playback range. The ringtone playback range is, for example, the range at which the ringtone will be heard when played by the device. One factor that can affect the ringtone playback range may be, for example, the volume that the device can play a ringtone. Thus, the ringtone playback capability information associated with the device may include how loud the device can playback a ringtone and the resulting range, which may be determined based on known sound damping levels in relation to distance. Based on this processing, the advertisement platform 103 can determine a range within which to determine whether there are neighboring devices.

Another factor that can affect the ringtone playback capability is the ambient noise that is present in the location in the device. The louder the ambient noise, the shorter the distance the sound of the ringtone playback will carry. Thus, in one embodiment, the advertisement platform 103 can process the contextual information to determine ambient noise information and base the ringtone playback range on the ambient noise information. The louder the ambient noise, the smaller the ringtone playback range and the smaller the area the advertisement platform 103 may consider when determining neighboring devices.

In one embodiment, the advertisement platform 103 also may process contextual information to rank the neighboring devices based on physical proximity, social proximity, or both. By way of example, physical proximity is determined based on the nearness in location to the user device that requests the ringtone from the advertisement platform 103. By way of example, social proximity is determined based on the proximity of neighboring devices associated with user profile information, user preference information, location information, temporal information, activity information, or a combination. Upon determining the ranking, the advertisement platform 103 may determine one or more weighting values for the one or more neighboring devices based on the ranking and process the contextual information to determine the ringtone based on the ranking.

In one embodiment, the advertisement platform 103 may process the contextual information to determine one or more lists of one or more candidate ringtones for the device, one or more neighboring devices, or a combination thereof. The advertisement platform 103 may determine the lists based on a monitoring of the contextual information. The monitoring may be performed continuously, periodically, according to a schedule, on demand, or a combination thereof. Based on the monitoring, the advertisement platform 103 may cause an updating of the one or more lists, a selected ringtone from the one or more lists, or a combination thereof. Accordingly, the advertisement platform 103 may monitor for changes in the locations of the devices and continuously determine selected ringtones for selected devices based on the continuously determined locations of the devices and neighboring devices.

The lists may be determined based on popularity information of the ringtones in comparison to one or more metrics. Thus, in one embodiment, the advertisement platform 103 also may determine popularity information associated with the candidate ringtones and determine selected ringtones based on the popularity information. The popularity information may be determined based on, for example, users' profiles that may be based on, for instance, metrics associated with users' interests, shopping histories, home/office locations, etc.

In one embodiment, the advertisement platform 103 may process the contextual information to determine advertisement information. By way of example, the location of a device and neighboring devices may be located within a certain proximity to a retail establishment. The retail establishment may be associated with the advertisement platform 103 to provide advertisements within provided ringtones. Accordingly, based on the location being within the proximity of the retail establishment, the advertisement platform 103 may select a ringtone that includes an advertisement associated with the retail establishment to play at the requesting device. When the requesting device plays the ringtone, the users of the device and the neighboring devices will hear the advertisement and may be further motivated to shop at the retail establishment compared to if they had not heard the advertisement. Where there are multiple retail establishments within a given location of devices, the selected advertisement that is included in the provided ringtone may be based on several factors that include, for example, the preferences of the users of the device and the neighboring devices, one or more metrics associated with the associations between the multiple retail establishments and the provider of the advertisement platform 103 (e.g., contract price, number of advertisements, length of association, etc.).

In one embodiment, the advertisement platform 103 provides additional awareness over the ownership of a played ringtone. When a user hears a ringtone playing, the advertisement platform 103 may help the user more easily and quickly perceive ownership over the ringtone (e.g., that the ringtone is playing on the user's device). In one embodiment, the advertisement platform 103 may cause the user's device that is playing the ringtone to cause one or more additional interactions, such as vibrate. Thus, the vibration of the device in addition to hearing the ringtone may cause the owner of the device to be more aware of the ownership of the origination of the ringtone. In one embodiment, the advertisement platform 103 may cause the provided ringtone to be mixed with another sound, such as the native/original ringtone of the user's device. The advertisement platform 103 may combine the native ringtone and the provided ringtone using audio processing techniques with the native ringtone being played in the background and with the provided ringtone being played in the foreground. The advertisement platform 103 may also, or in the alternative, perform time interleaving such that the native ringtone is played for a time period T1 followed by the provided ringtone for a time period T2.

By way of example, the UE 101, the advertisement platform 103, the services platform 107 and the content providers 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

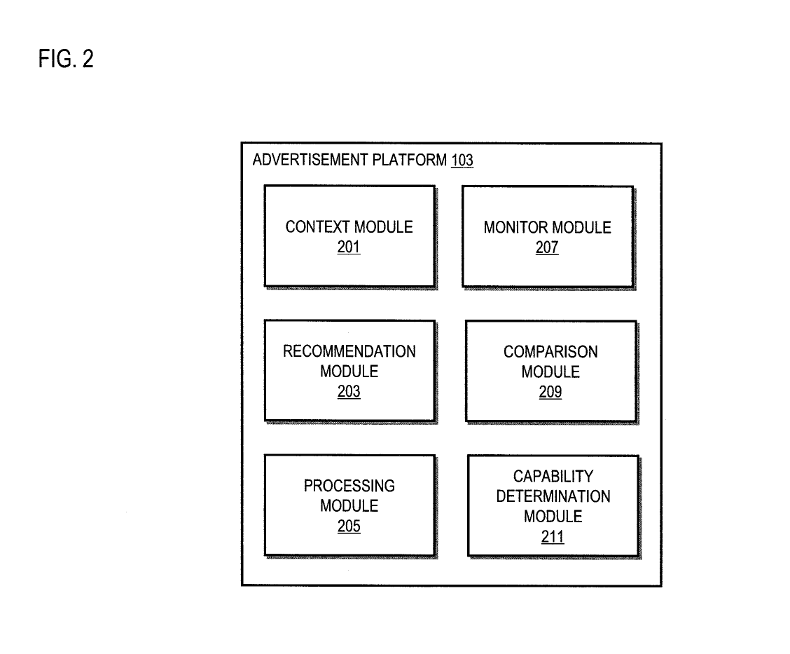

FIG. 2 is a diagram of the components of the advertisement platform 103, according to one embodiment. By way of example, the advertisement platform 103 includes one or more components for providing neighborhood-based ringtone advertisements. As discussed above, it is contemplated that the functions of these components may be combined in one or more components or performed by other components of equivalent functionality. In this embodiment, the advertisement platform 103 includes a context module 201, a recommendation module 203, a processing module 205, a monitor module 207, a comparison module 209, and a capability determination module 211.

The context module 201 enables the advertisement platform 103 to determine the contextual information associated with a device and a neighboring device by collecting or determining contextual information associated with the device and the neighboring device. In one embodiment, the context module 201 may determine contextual information from the profile database 117, the applications 111 executed at the UE 101, the sensors 115 associated with the

UE 101, and/or one or more services 109 on the services platform 107. As the UE 101 sends a request for ringtone advertisement to the advertisement platform 103, the context module 201 provides the advertisement platform 103 with contextual information. The contextual information provided to the advertisement platform 103 can be, for example, user profile information, user preference information, temporal information, location information, activity information or a combination.

For example, the advertisement platform 103 selects the ringtone advertisement on the basis of user preference. In one embodiment, the context module 201 may track the exchange of audio files for particular users. In this manner, the statistical data that is obtained may be used for any suitable purpose, including the selection of ringtones. The data may include, for example but not limited to, popularity of particular ringtones, popularity of ringtones as a function of the age of the user, popularity of ringtones as a function of the time of day, popularity of ringtones as a function of the region of the country, popularity of ringtones as a function of the sex of the user, popularity of ringtones as a function of the demographics of the user, popularity of ringtones as a function of the income of the user, popularity of ringtones as a function of the duration of use by the user, popularity of ringtones as a function of the work culture of the user, popularity of ringtones as a function of the genre of the corresponding audio files, etc.

The recommendation module 203 recommends the ringtone based on the preferences of the users associated with the UE 101, which are determined once the contextual information is processed by the processing module 205. As the context module 201 determines contextual information, the processing module 205 processes the contextual information. Next, the recommendation module 203 recommends, according to the rankings of the neighboring devices based on their physical, or social proximity, or both, the selection of ringtone based on determined popularity information. The recommendation module 203 determines whether a preferred ringtone advertisement for the requesting UE 101 is available or not. If a preferred ringtone is not available, the recommendation module 203 recommends a ringtone preference to the advertisement platform 103. In one embodiment, the advertisement platform 103 then requests the ringtone from, for example, one or more content providers 113.

The processing module 205 enables the advertisement platform 103 to process the contextual information to determine: (a) ringtones for devices, (b) ringtone playback capability information to determine the ringtone playback range, (c) ambient noise information to ascertain ringtone playback range, (d) rankings of neighboring devices based on physical and social proximity, and (e) selection of ringtones based on the preference and popularity amongst the users of UE 101. The processing module 205 may include one or more algorithms that are executed in performing the processing.

The monitor module 207 monitors the profile database 117, the ringtone database 119 and the location database 121. The monitor module 207 keeps the databases updated. Each time a UE 101 sends a ringtone request, the monitor module 207 compares the contextual information and updates the contextual information in the profile database 117, the ringtone database 119 and the location database 121. The monitor module 207 monitors for updates continuously, periodically, according to a schedule, on demand, or a combination thereof. In one embodiment, the monitor module 207 ensures that the ringtones are free from encryptions that may limit their use, inhibit their copying, inhibit or otherwise limit the number of copies that may be made, time limited durations, etc. In this manner, the ringtones are freely transferable from one UE 101 to another, while operating properly.

The comparison module 209 compares the contextual information and prioritizes the ringtone advertisements based on user contexts. The comparison module 209 pulls information from the profile database 117, the ringtone database 119 and the location database 121. The comparison module compares the data and transmits the data to the recommendation module 203.

The capability determination module 211 determines the ringtone playback capability and the neighborhood devices that are determined based on the ringtone playback range of the UE 101. As the neighborhood users change, the capability determination module 211 determines the neighborhood users by determining the dynamic neighborhood range. In one embodiment, the capability determination module 211 determines the dynamic neighborhood range by processing microphone volume levels associated with ringtone requests.

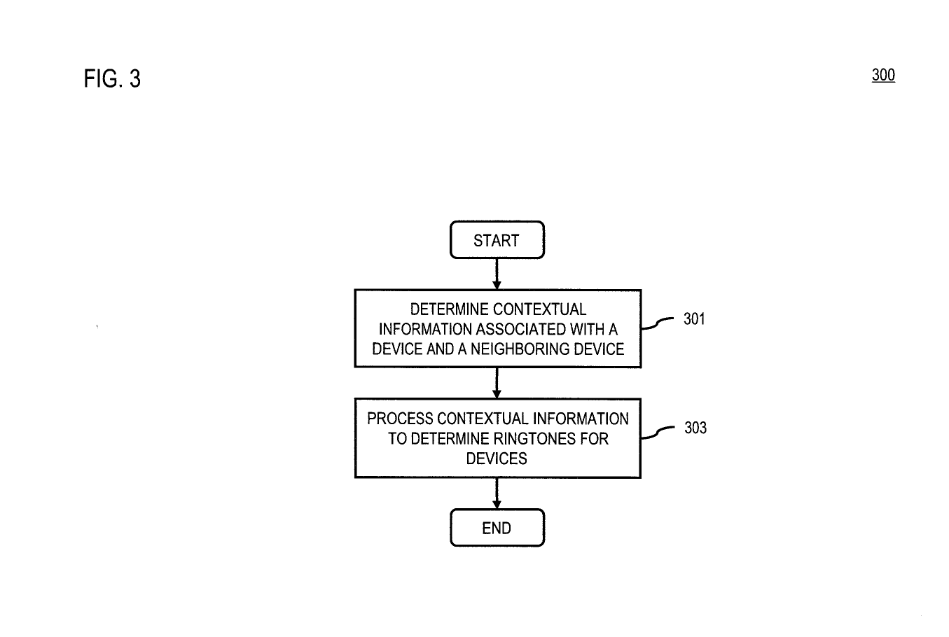

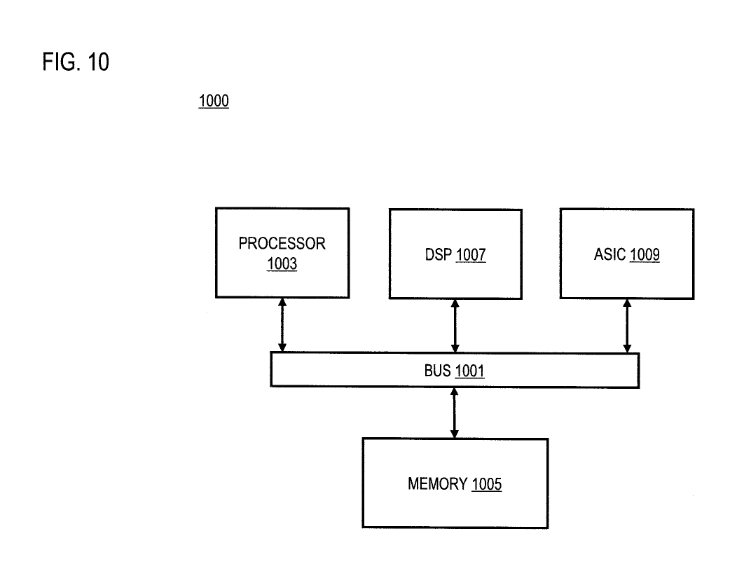

FIG. 3 is a flowchart of a process for determining a ringtone for a device, according to one embodiment. In one embodiment, the advertisement platform 103 performs the process 300 and is implemented in, for instance, a chip set including a processor and a memory as shown in FIG. 10.

In step 301, a request for a ringtone is sent from a UE 101 to the advertisement platform 103. The request may be sent prior to the UE 101 playing a ringtone, such as upon receiving an incoming call, SMS message, MMS message, email and prior to playing a sound in response. Such transmission of the request between the UE 101 and the advertisement platform 103 will result in the advertisement platform 103 determining the contextual information associated with the UE 101 and one or more neighboring devices of the UE 101. Thus, the advertisement platform 103 takes into consideration the contexts of other devices and/or users who are nearby the UE 101. The contextual information determined by the advertisement platform 103 may include, for example, user profile information, user preference information, location information, temporal information, activity information, or a combination. The contextual information may be determined from one or more applications 111 executed by the UE 101 and/or the neighboring devices, one or more sensors 115 associated with the UE 101 and/or the neighboring devices, one or more services 109 on the services platform 107, and/or content providers 113.

In step 303, the advertisement platform 103 processes the contextual information to determine a suitable ringtone for the UE 101. As discussed in detail below, the advertisement platform 103 may process the contextual information to determine a range associated with the playback of the ringtone and the neighboring devices that are within the range and that are associated with users who will hear the playback of the ringtone. The advertisement platform 103 may further determine the context information associated with the neighboring devices to determine the preferences of the users of the devices to determine a ringtone that will be generally preferred by all of the users that will be in the vicinity to hear the ringtone. The advertisement platform 103 may also consider the preferences of the user of the requesting UE 101. Accordingly, the advertisement platform 103 may provide a ringtone to the requesting UE 101 based on the neighboring devices of the requesting UE 101.

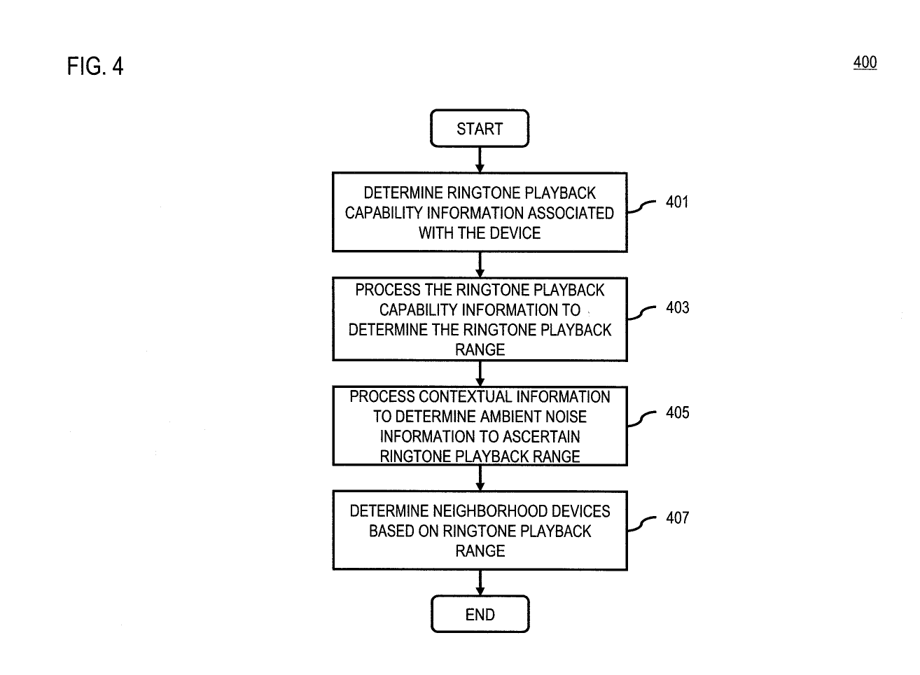

FIG. 4 is a flowchart of a process for determining a ringtone playback range, according to one embodiment. In one embodiment, the advertisement platform 103 performs the process 400 and is implemented in, for instance, a chip set including a processor and a memory as shown in FIG. 10.

In step 401 the advertisement platform 103 determines the ringtone playback capability information associated with the requesting UE 101. For example, the ringtone playback capability information may include the ringtone volume of the requesting UE 101 based on the current perceived volume of digital audio playback. In one embodiment, the UE 101 allows the end user to select different, independent volume control capabilities for ringtones and digital audio playback. For example, a relatively coarse level of volume control is provided for ringtones based on a small set of predefined volume levels such as, e.g., very loud, loud, medium, soft, very soft, and off. Whenever a ringtone needs to be played, the capability determination module 211 of the advertisement platform 103 may determine the current perceived volume of the mobile communication device.

The process continues to step 403 in which the advertisement platform 103 processes the ringtone playback capability information to determine the ringtone playback range. For example, the UE 101 may play ringtone audio content in response to user input; the capability determination module 211 monitors the present playback range of the ringtone audio content and provides the advertisement platform 103 with the information on ringtone playback capability.

In one embodiment, the process may proceed to step 405. However, in one embodiment, the process may proceed directly to step 407. At step 405, the advertisement platform 103 processes the contextual information to determine ambient noise information to, at least in part, ascertain the ringtone playback range. The UE 101 may include within the request the current microphone volume level of UE 101 for the advertisement platform 103 to determine the ambient noise information associated with the request. In one embodiment, the UE 101 may determine whether the ambient noise information has changed within a set threshold. If there is no change, the UE 101 may exclude the ambient noise information and the advertisement platform 103 may rely on any previously sent ambient noise information. The advertisement platform 103 may estimate the effective spatial coverage of the ringtone playing at this specific time and find all current nearby users of this request from location database by taking into consideration the ambient noise information. By way of example, the effective ringtone playback range is smaller when the ambient noise information indicates that the ambient noise is higher based on the damping qualities in relation to distance and ambient noise levels.

The process continues to step 407 in which the advertisement platform 103 determines the neighborhood devices based on ringtone playback range. For example, when a ringtone request is received from the UE 101, the advertisement platform 103 processes the ringtone playback capability information of the UE 101 to determine the ringtone playback range. Next, the advertisement platform obtains information from the location database 121 regarding available neighboring users of UE 101 who fall within the spatial coverage of the ringtone volume level based on the ringtone playback range. Based on the location information, the advertisement platform 103 determines the neighboring devices.

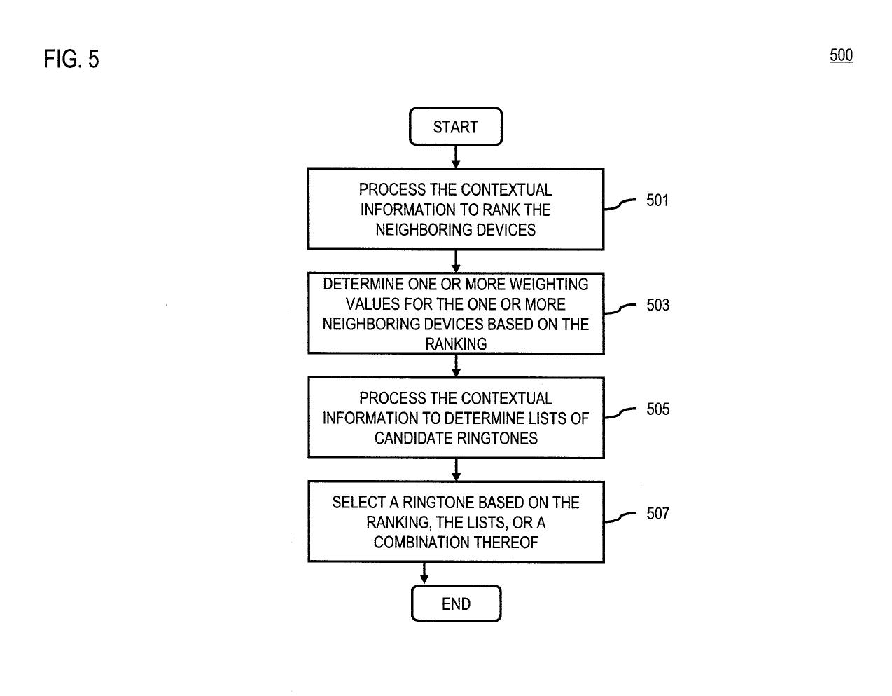

FIG. 5 is a flowchart of a process for determining a provided ringtone, according to one embodiment. In one embodiment, the advertisement platform 103 performs the process 500 and is implemented in, for instance, a chip set including a processor and a memory as shown in FIG. 10.

In step 501, the advertisement platform processes the contextual information to cause, at least in part, a ranking of the one or more neighboring devices based, at least in part, a physical proximity, a social proximity, or a combination thereof to the at least one device. The physical proximity may determined based on the nearness in location the neighboring devices are to the user device that requests the ringtone from the advertisement platform 103. The social proximity is determined based on the proximity of neighboring devices associated with user profile information, user preference information, location information, temporal information, activity information, or a combination. By way of example, one type of social proximity may be the social relationship between the owners of two devices as established on a social networking service 109a. For instance, two owners of devices may simply be designated as acquaintances on the social networking service 109, one of the owners and another owner may be designated as friends on the social networking service 109, while one of the owners and another owner may be designated as family. The various designations may represent rankings of the owners, such that the family is ranked highest and the mere acquaintance is ranked the lowest among the group of owners in terms of the social proximity.

In step 503, the advertisement platform 103 determines one or more weighting values for the one or more neighboring devices based, at least in part, on the ranking The advertisement platform 103 may weigh the variously ranked neighboring devices different such that, for example, higher ranked devices and given a larger weighting in terms of determining a ringtone than lower ranked devices. By way of example, in terms of physical proximity, devices that are ranked higher because they are closer to the requesting device may be given a higher weighting. This higher weighting may reflect the better chance the users of the closer devices have to hearing the ringtone. Because the users of the closer devices have a better chance in hearing the ringtone, the advertisement platform 103 weights their preferences in ringtones more so that they hear a ringtone that they prefer, rather than a ringtone that someone farther away prefers yet is less likely to hear. By way of another example, in terms of social proximity, devices that are ranked higher in social proximity may be given higher weightings because the user of the requesting device may give higher significance to, for example, the opinions of the users of the higher socially ranked devices. The advertisement platform 103 may place more significance in what close family members prefer to hear rather than merely close acquaintances.

In step 505, the advertisement platform 103 may process the contextual information to determine one or more lists of one or more candidate ringtones for the at least one device, the one or more neighboring devices, or a combination thereof. Based on the determination of the neighboring devices, the advertisement platform 103 can determine one or more lists of preferred ringtones associated with the one or more devices that are stored in, for example, the profiles database 117. The lists may be created based on the advertisement platform 103 acquiring information regarding user preferences that are related to the ringtones, such that a device associated with a user is associated with a preferred list of ringtones. Each list may correspond to, therefore, candidate ringtones that may be further processed to select a ringtone.

In step 507, after determining the rankings and the candidate lists of ringtones, the advertisement platform processes the contextual information and selects a ringtone from the lists. Where the selection is based solely on the lists, the advertisement platform 103 may determine the ringtone based on any type of analysis with respect to the lists. By way of example, the advertisement platform 103 may select the ringtone with the highest average position among the lists, the ringtone with the most occurrences as the first ringtone, and so forth. The determination may further be adjusted based on the ranking and weighting from step 503. For example, the lists associated with devices and/or users that include a higher ranking may be consider more than the lists associated with the devices and/or users that include lower rankings. Thus, even though one ringtone may be listed as the most preferred ringtone on many lists, these lists may not be ranked as highly as other lists that include a different ringtone as the most preferred ringtone. Accordingly, based on the lists and the rankings, the advertisement platform 103 determines a ringtone to provide the requesting device for playback.

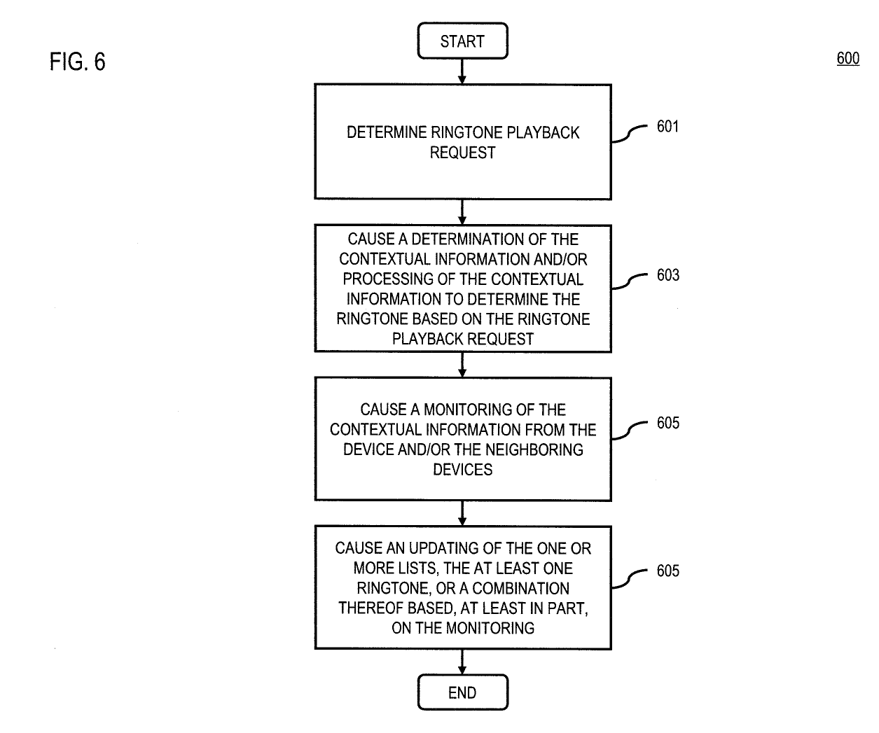

FIG. 6 is a flowchart of a process for determining updates in context information, according to one embodiment. In one embodiment, the advertisement platform 103 performs the process 600 and is implemented in, for instance, a chip set including a processor and a memory as shown in FIG. 10.

In step 601 the advertisement platform 103 determines a ringtone playback request for a device. For example, the advertisement platform 103 receiving a request message from UE 101, and the request may include information regarding the type of ringtone service that needs to be played. The processing module 205 may process the request message from UE 101.

Next, in step 603, the advertisement platform 103 causes, at least in part, an initiation of the determining of the contextual information, the processing of the contextual information to determine the at least one ringtone, or a combination thereof based, at least in part, on the ringtone playback request. Thus, in one embodiment, the advertisement platform 103 may process the context information that is currently in the profiles database 117, the ringtone database 119, and the location database 121 based on receipt of the ringtone request to determine a selected ringtone for the request device. However, in one embodiment, the advertisement platform 103 may initiate a determination of the contextual information from the requesting device and neighboring devices. Thus, the advertisement platform 103 may initiate a determination of context information of the devices (e.g., UE 101), the applications 111 associated with the devices and the sensors 115 associated with the devices, in addition to other context information associated with the devices that may be provided by, for example, one or more services 109 and/or one or more content providers 113.

In step 605, in one embodiment, the advertisement platform 103, may cause, at least in part, a monitoring of the contextual information from the at least one device, the one or more neighboring devices, or a combination thereof continuously, periodically, according to a schedule, on demand, or a combination thereof. Thus, after the contextual information is determined by the advertisement platform 103, the advertisement platform 103 may monitor for changes in the contextual information. As discussed, the monitoring can be based on any monitoring schedule.

In step 607, the advertisement platform 103 causes, at least in part, an updating of the one or more lists, the at least one ringtone, or a combination thereof based, at least in part, on the monitoring. When the contextual information changes as determined based on the monitoring, the advertisement platform 103 can update any or all of the lists and provided ringtones based on the changes. In one embodiment, the changes in the contextual information that result in an update of the lists and/or ringtone may occur if the changes satisfy one or more thresholds. For example, changes in the locations of the devices may trigger updates to the ringtone if the changes in the location satisfy a location change threshold. Thus, the advertisement platform 103 may not change, for example, the ringtone after every small change in the context information.

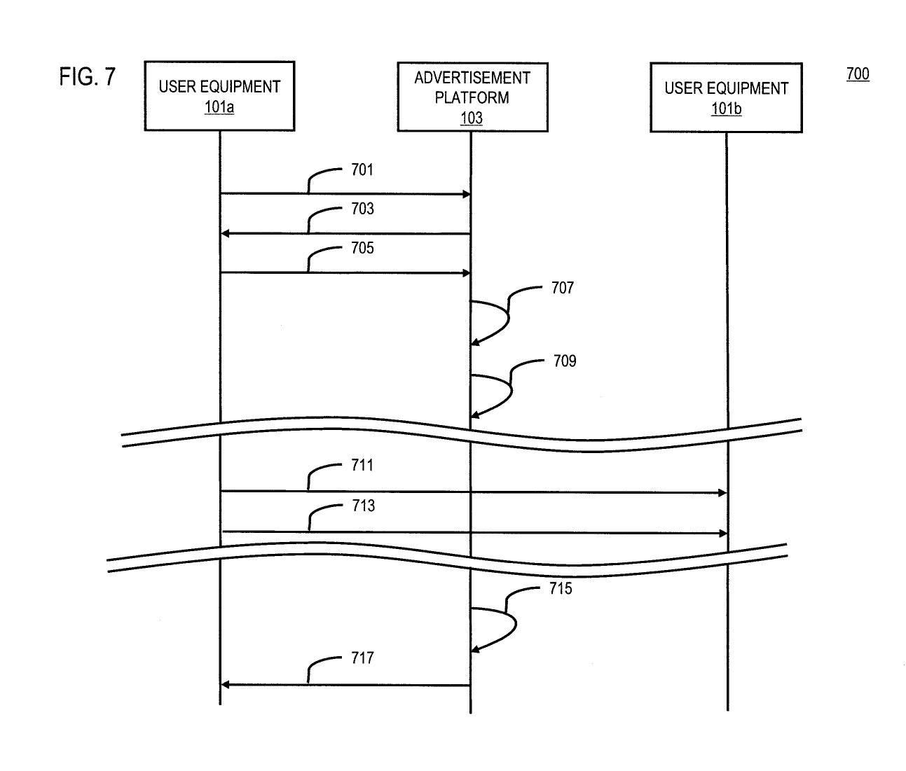

FIG. 7 is a ladder diagram that illustrates a sequence of processes used in determining a neighborhood-based ringtone advertisement, according to one embodiment. In step 701, a UE 101a generates a request for a ringtone and/or an advertisement and sends the request to the advertisement platform 103. The advertisement platform 103 retrieves the contextual information of the UE 101a from the applications 111, the sensors 115, the databases 117, 119 and 121, and processes the contextual information to obtain, for example, the current location of the UE 101a. In one embodiment, the advertisement platform 103 sends a request to the UE 101a to update the contextual information (step 703). For example, when the user of UE 101 powers up the UE 101, the UE 101 listens for a system identification code on the control channel. The control channel is a special frequency that the phone and base station use to talk to one another about things like call set-up and channel changing. When the advertisement platform 103 receives the system identification code, the advertisement platform 103 compares the system identification code to the code programmed in, for example, the profiles database 117. Along with the system identification code, the UE 101 also transmits a registration request, and the advertisement platform 103 keeps track of the user's phone location in a database. The advertisement platform 103 gets the call and attempts to find the user's phone. It then picks a frequency pair and communicates with the user's phone over the control channel to tell it which frequencies to use, and once the UE 101 and the tower switch on those frequencies, the call is connected. In step 705, the UE 101 sends the updated contextual information, if any, to the advertisement platform 103.

The advertisement platform 103 then estimates the effective spatial coverage of the ringtone to determine the dynamic neighborhood range in real-time at a specific time of ringtone playing (step 707). This may be performed based on the advertisement platform 103 determining the ringtone playback capability of the UE 101a, the ambient noise information associated with the location of the UE 101a, or a combination thereof.

In step 709, the advertisement platform 103 searches for current nearby user equipment from the location database 121. The ringtone coverage may be measured to determine the neighboring UE 101. As discussed above, the location database 121 may include the location information associated with the UE 101 based on the update of context information. In one embodiment, the advertisement platform 103 may register the UE 101 in the location database 121 according to areas. When the UE 101 pass between areas, the UE 101 may notify the advertisement platform 103 and/or the location database 121 that the UE 101 are entering or leaving the logged location areas. Thus, the advertisement platform 103 may determine the neighboring UE 101 based on the information within the location database 121.

In one embodiment, the UE 101a that requested the ringtone may include within the request location information regarding the neighboring UE 101a. As illustrated in FIG. 7, in such an embodiment, the UE 101a may broadcast a signal that other UE 101 within the vicinity of the UE 101a may receive (step 711). The signal may be sent using short range communications, such as Bluetooth, WiFi Direct, etc. The UE 101 that are within the vicinity of the UE 101a that receive the signal may then respond back to the UE 101 in a peer-to-peer communication approach with information regarding their locations (step 713). Upon the UE 101a sending the request for the ringtone from the advertisement at step 701, the request may already include the information regarding the UE 101 that are within the vicinity of the UE 101a. In such an embodiment, the advertisement platform 103 can, for example, skip steps 707 and 709 discussed above. Although steps 711 and 713 appear after step 709 in FIG. 7, they may instead occur prior to step 701 such that the request in step 701 may include the location information regarding the neighboring UE 101.

In step 715, the advertisement platform 103 then computes the set of preferred ringtones based on the collected information, including the UE 101 in the vicinity of the UE 101a and the information associated with the users of the UE 101, such as the users' preferences. The advertisement platform 103 processes the request to get a suitable ringtone advertisement and transmits the ringtone to the UE 101a (step 717).

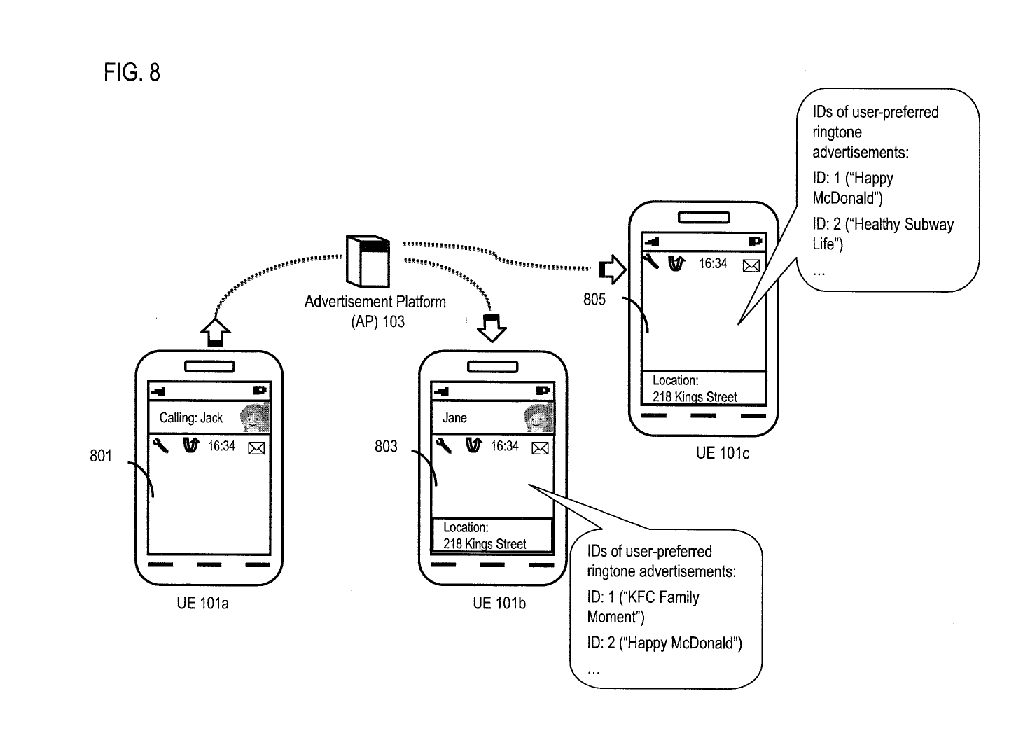

FIG. 8 is a diagram of user interfaces utilized in the processes of FIGS. 4-6, according to various embodiments. Illustrated are UE 101a, UE 101b and UE 101c having user interfaces 801, 803 and 805, respectively. Whenever a ringtone is to be played on, for example, UE 101a, the advertisement platform 103 dynamically selects a ringtone based on the contextual information of the UE 101a, UE 101b, and UE 101c. As discussed above, the contextual information includes, but is not limited to, user profile information, user preference information, location information, temporal information, activity information, or a combination thereof. By way of example, the UE 101a sends a request to the advertisement platform 103 to get a suitable ringtone advertisement each time the UE 101a will audibly respond to an action or event at the UE 101a (e.g., prior to receiving a call, a SMS message, a MMS message, an email, etc.). At the specific time the ringtone will play, the dynamic neighborhood range is determined in real time based on the UE 101a sending the current microphone volume level in the ringtone request. However, as discussed above, the current microphone volume level request need not be sent if the volume level has not changed within a certain threshold since the previous ringtone request. Once the volume level is sent, the advertisement platform 103 estimates the effective spatial coverage of ringtone playing at this specific time. The advertisement platform 103 finds the nearby UE 101b and UE 101c from the location database 121 and determines whether the nearby UE 101b and UE 101c will be within the effective spatial coverage area of the ringtone. If the UE 101b and UE 101c will be within the effective spatial coverage area of the ringtone, the advertisement platform 103 determines and processes the contextual information associated with the UE 101b and UE 101c to determine a ringtone that has the best influence on the group of all users (e.g., the users of the UE 101a, UE 101b, and UE 101c). By way of example, as illustrated, the user of UE 101b prefers ID1: KFC Family Moment and ID2 Happy McDonald, while the user of UE 101c prefers ID1: Happy McDonald and ID2 Healthy Subway Life. Thus, based on these preferences, the advertisement platform 103 may choose, for example, to play the ringtone associated with Happy McDonald.

According to another embodiment based on the peer-to-peer approach, the UE 101 near to each other in location collaboratively pick the ringtone advertisement in a peer-to-peer (P2P) manner The advertisement platform 103 stores the IDs of the UE 101 preferred ringtone advertisements. When the UE 101a is about to ring, a ringtone broadcast request is sent to all nearby UE 101. The neighboring UE 101 respond with their own set of IDs, which may be sent by the UE 101a to the advertisement platform 103. The advertisement platform 103 will then provide a preferred ringtone ID set for all of the UE 101 in the neighboring range and determine a ringtone that has the best influence on the group of all users. The ringtone may then be provided to the UE 101a.

The processes described herein for neighborhood-based ringtone advertisement may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

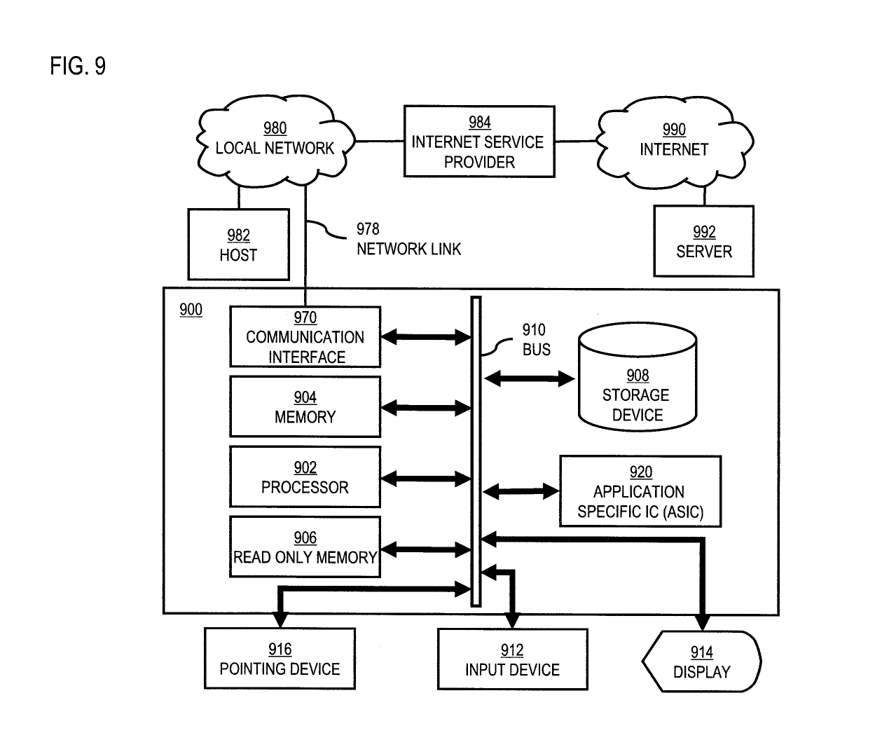

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to provide neighborhood-based ringtone advertisements as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of neighborhood-based ringtone advertisement.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to neighborhood-based ringtone advertisement. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for neighborhood-based ringtone advertisement. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for neighborhood-based ringtone advertisement, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for neighborhood based ringtone advertisement to the UE 101.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infrared transmitter to convert the instructions and data to a signal on an infrared carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to provide neighborhood-based ringtone advertisements as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of neighborhood-based ringtone advertisement.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to perform specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to neighborhood-based ringtone advertisement. The memory 1005 also stores the data associated with or generated by the execution of the inventive steps.

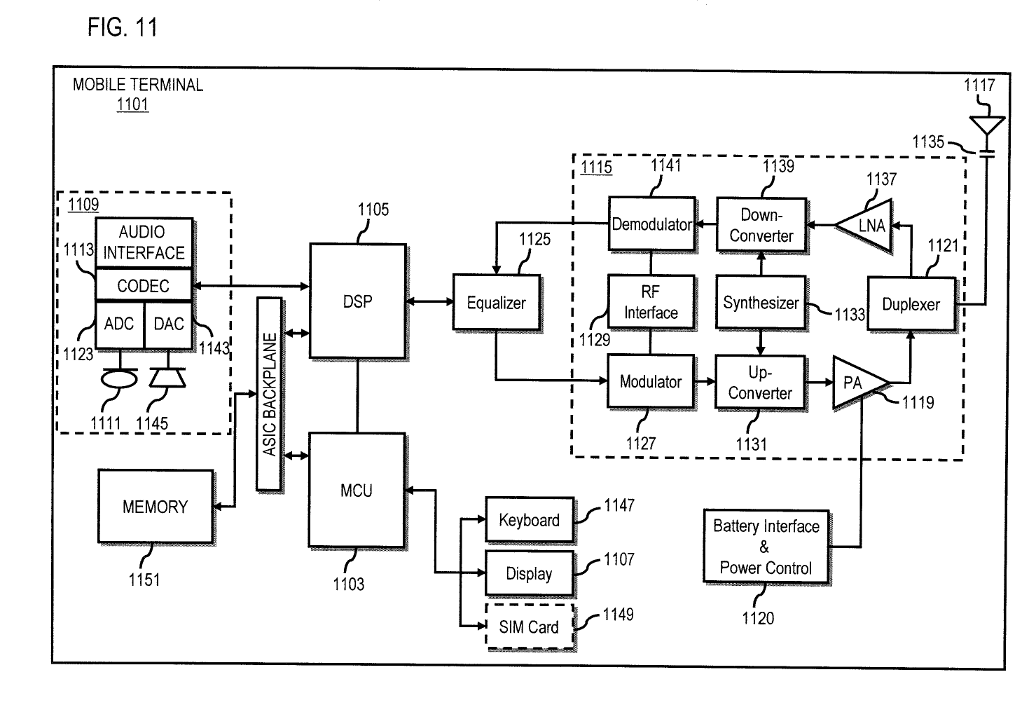

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of neighborhood-based ringtone advertisement. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of neighborhood-based ringtone advertisement. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to neighborhood-based ringtone advertisement. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims Although features of the invention are expressed in certain combinations among the claims, it is contemplated that these features can be arranged in any combination and order.

1-38. (canceled)

39. A method comprising:
determining contextual information associated with at least one device and one or more neighboring devices; and
processing and/or facilitating a processing of the contextual information to determine at least one ringtone for the at least one device.

40. A method of claim 39, further comprising:
determining ringtone playback capability information associated with the at least one device;
processing and/or facilitating a processing of the ringtone playback capability information to determine at least one ringtone playback range; and
determining the one or more neighboring devices based, at least in part, on the at least one ringtone playback range.

41. A method of claim 40, further comprising:
processing and/or a facilitating a processing of the contextual information to determine ambient noise information,
wherein the at least one ringtone playback range is further based, at least in part, on the ambient noise information.

42. A method of claim 39, further comprising:
processing and/or facilitating a processing of the contextual information to cause, at least in part, a ranking of the one or more neighboring devices based, at least in part, on a physical proximity, a social proximity, or a combination thereof to the at least one device; and
determining one or more weighting values for the one or more neighboring devices based, at least in part, on the ranking,
wherein the processing of the contextual information to determine the at least one ringtone is further based, at least in part, on the ranking.

43. A method of claim 39, further comprising:
processing and/or a facilitating a processing of the contextual information to determine one or more lists of one or more candidate ringtones for the at least one device, the one or more neighboring devices, or a combination thereof; and
causing, at least in part, a selection of the at least one ringtone from the one or more lists.

44. A method of claim 43, further comprising:
causing, at least in part, a monitoring of the contextual information from the at least one device, the one or more neighboring devices, or a combination thereof continuously, periodically, according to a schedule, on demand, or a combination thereof; and
causing, at least in part, an updating of the one or more lists, the at least one ringtone, or a combination thereof based, at least in part, on the monitoring.

45. A method of claim 43, further comprising:
determining popularity information associated with the one or more candidate ringtones, wherein the determining of the at least one ringtone is further based, at least in part, popularity information.

46. A method of claim 39, further comprising:
determining a ringtone playback request for the at least one device; and
causing, at least in part, an initiation of the determining of the contextual information, the processing of the contextual information to determine the at least one ringtone, or a combination thereof based, at least in part, on the ringtone playback request.

47. A method of claim 39, further comprising:
processing and/or facilitating a processing of the contextual information to determine advertisement information,
wherein the at least one ringtone includes, at least in part, the advertisement information.

48. An apparatus comprising:
at least one processor; and
at least one memory including computer program code for one or more programs, the at least one memory and the computer program code configured to, with the at least one processor, cause the apparatus to perform at least the following, determine contextual information associated with at least one device and one or more neighboring devices; and
process and/or facilitate a processing of the contextual information to determine at least one ringtone for the at least one device.

49. An apparatus of claim 48, wherein the apparatus is further caused to:
determine ringtone playback capability information associated with the at least one device;
process and/or facilitate a processing of the ringtone playback capability information to determine at least one ringtone playback range; and
determine the one or more neighboring devices based, at least in part, on the at least one ringtone playback range.

50. An apparatus of claim 49, wherein the apparatus is further caused to:
process and/or a facilitate a processing of the contextual information to determine ambient noise information,
wherein the at least one ringtone playback range is further based, at least in part, on the ambient noise information.

51. An apparatus of claim 48, wherein the apparatus is further caused to:
process and/or facilitate a processing of the contextual information to cause, at least in part, a ranking of the one or more neighboring devices based, at least in part, on a physical proximity, a social proximity, or a combination thereof to the at least one device; and
determine one or more weighting values for the one or more neighboring devices based, at least in part, on the ranking,
wherein the processing of the contextual information to determine the at least one ringtone is further based, at least in part, on the ranking.

52. An apparatus of claim 48, wherein the apparatus is further caused to:
process and/or a facilitate a processing of the contextual information to determine one or more lists of one or more candidate ringtones for the at least one device, the one or more neighboring devices, or a combination thereof; and
cause, at least in part, a selection of the at least one ringtone from the one or more lists.

53. An apparatus of claim 52, wherein the apparatus is further caused to:
cause, at least in part, a monitoring of the contextual information from the at least one device, the one or more neighboring devices, or a combination thereof continuously, periodically, according to a schedule, on demand, or a combination thereof; and
cause, at least in part, an updating of the one or more lists, the at least one ringtone, or a combination thereof based, at least in part, on the monitoring.

54. An apparatus of claim 52, wherein the apparatus is further caused to:
determine popularity information associated with the one or more candidate ringtones, wherein the determining of the at least one ringtone is further based, at least in part, popularity information.

55. An apparatus of claim 48, wherein the apparatus is further caused to:
determine a ringtone playback request for the at least one device; and
cause, at least in part, an initiation of the determining of the contextual information, the processing of the contextual information to determine the at least one ringtone, or a combination thereof based, at least in part, on the ringtone playback request.

56. An apparatus of claim 48, wherein the apparatus is further caused to:
process and/or facilitate a processing of the contextual information to determine advertisement information,
wherein the at least one ringtone includes, at least in part, the advertisement information.

57. A computer program product including one or more sequences of one or more instructions which, when executed by one or more processors, cause an apparatus to at least perform the steps:
determining contextual information associated with at least one device and one or more neighboring devices; and
processing and/or facilitating a processing of the contextual information to determine at least one ringtone for the at least one device.

58. A computer program product of claim 57, wherein the apparatus is caused, at least in part, to further perform:
determining ringtone playback capability information associated with the at least one device;
processing and/or facilitating a processing of the ringtone playback capability information to determine at least one ringtone playback range; and
determining the one or more neighboring devices based, at least in part, on the at least one ringtone playback range.
